(19) United States
(12) Patent Application Publication
(10) Pub. No.: US 2014/0016989 A1
(43) Pub. Date: Jan. 16, 2014

(54) RECYCLABLE RING BINDER APPARATUS WITH QUICK RELEASE RING METALS

(71) Applicant: STRIDE MANUFACTURING, LLC, Reno, NY (US)

(72) Inventors: Brian R. Brennan, Verdi, NV (US); Patrick H. Brennan, Albuquerque, NM (US)

(73) Assignee: STRIDE MANUFACTURING, LLC, Reno, NV (US)

(21) Appl. No.: 14/024,439

(22) Filed: Sep. 11, 2013

Related U.S. Application Data
(63) Continuation of application No. 12/134,844, filed on Jun. 6, 2008, now Pat. No. 8,585,311.

(51) Int. Cl. B42F 3/04

(52) U.S. Cl. CPC B42F 3/04
USPC 402/75

(57) ABSTRACT

A recyclable ring binder apparatus comprises a ring metal incorporating a set of binder rings that are formed of a pair of ring halves. The ring metal can be firmly fastened to a spine section of a binder hardcover by utilizing a post and a small arched snap clamp with a tap. The tap of the snap clamp can be pressed around a neck of the post utilizing a quick release clipping mechanism. The snap clamp can be accessed with an index finger and slid away from the post to remove the ring metal from the hardcover. The ring metal, the hardcover, the snap clamp and the post can be quickly separated into their perspective categories due to the clipping mechanism. Hence, it retains conformance of all components of the ring binder apparatus for recycling without increasing development and production cost.

### CROSS REFERENCE TO RELATED APPLICATION

This Application is a continuation of, and claims priority through, Applicant's prior U.S. patent application Ser. No. 12/134,844, filed Jun. 6, 2008, entitled “Recyclable Ring Binder Apparatus with Quick Release Ring Metals,” which prior Application is hereby incorporated herein by reference in its entirety.

### TECHNICAL FIELD

Embodiments are generally related to binders for maintaining loose-leaf paper. Embodiments are also related to recyclable ring binders for binding loose-leaf papers to form books or booklets. Embodiments are additionally related to quick release ring components and accessories utilized in the context of recyclable binders.

### BACKGROUND OF THE INVENTION

Many different techniques, such as, for example comb binders, spiral wire binders, coil binders, paper clips or staples, three-ring binders, pocket organizers and mechanical binders, are utilized to bind and organize printed paper materials and form a book binding. Such binders and devices are utilized in virtually every factory, office, school and home, Typical considerations in the use of such binders include cost, ease of use, and the ability to stand, label and protect the bound materials as well as the ability to bind the paper materials on-site in a timely manner.

Three-ring binders are a popular means of binding and organizing printed paper materials, and commonly comprise a binder hardcover and a ring binding mechanism. The ring binding mechanism includes a base, to which a set of rings is connected. Each ring can exhibit two semi-circular prongs that are mated at one point to form a generally circular ring. Mating ends of each ring can be separated at the mating point to permit the insertion of papers or other articles for storage within the binder.

Moreover, the base of the ring binding mechanism may be permanently attached to the hardcover. The hardcover provides protection for the papers maintained by the rings within the binder. The hardcover is commonly constructed utilizing, but not limited to synthetic, plastic-type materials and paperboard. The useful life of the three-ring type binder can end upon failure of the hardcover or the binding mechanism. Therefore, in the event of failure, the binding mechanism cannot be easily removed from the hardcover for recycling. Such a removal process requires additional tools, which leads to additional costs and is also time-consuming. Hence, such a device creates a problem of non-conformance of a product for recyclers due to damage of the binding mechanism, the hardcover and/or other related accessories. Such a damaged hardcover and/or metal rings are very difficult to interchange with different types of binding mechanisms.

In one prior art implementation, an interchangeable ring binder can be removably mated with a variety of binding mechanisms. Such an approach results in the reusing of the ring metals and not the hardcover, since the ring metals are permanently bonded with the hardcover utilizing suitable bonding materials. The ring metals may actually damage the hardcover, when the ring metals are removed from the hardcover. In the majority of prior art binder applications, such binders suffer certain disadvantages such as being non-recyclable, of high cost, time consumption, or the need for relatively complex tools for the binder removal process. Therefore, it is desirable to solve the problem of non-conformance of binder for recyclers.

In an effort to address the foregoing difficulties, it is believed that a need exists for an inexpensive and recyclable binder apparatus with quick release ring metals and accessories. It is believed that the recyclable binder apparatus disclosed herein can address these and other continuing needs.

### BRIEF SUMMARY

The following summary is provided to facilitate an understanding of some of the innovative features unique to the embodiments disclosed and is not intended to be a full description. A full appreciation of the various aspects of the embodiments can be gained by taking the entire specification, claims, drawings, and abstract as a whole.

It is, therefore, one aspect of the present invention to provide for an inexpensive and 100% recyclable ring binder apparatus for binding loose-leaf papers to form books or booklets,

It is another aspect of the present invention to provide for quick release ring metals and a clipping mechanism utilized in the context of a recyclable ring binder apparatus.

The aforementioned aspects and other objectives and advantages can now be achieved as described herein. A recyclable ring binder apparatus is disclosed, which includes a ring metal incorporating a set of binder rings formed from a pair of ring halves. The ring metal can be firmly fastened to a spine section of a binder hardcover utilizing a post and a small arched snap clamp with a tab and an opening or rounded portion. The opening or rounded of the snap clamp can be pressed around a neck of the post utilizing a quick release clipping mechanism. The snap clamp can be accessed with an index finger and slid away from the post to remove the ring metal from the hardcover. The ring metal, the hardcover, the snap clamp and the post can be quickly separated into their perspective categories due to the clipping mechanism. Hence, such an approach retains conformance of all components with respect to the ring binder apparatus for recycling without increasing development and production cost. The ring metal can go into the metal recycle bin and the paper board or the plastic cover can go in their respective recycling bins.

Furthermore, the recyclable ring binder apparatus disclosed can be flat and bound much like a hard back book utilizing recycled paper or cloth tape. The recyclable ring binder can be utilized for binding loose-leaf papers to form books or booklets. The binder hardcover can be designed, for example, as a chipboard and/or a plastic board, where the plastic board can be constructed of bio-degradable or recycled plastics. A set of release levers can be located at each end of the ring metal and operable by a user to open and close the binder rings. Such ring binders can be easily detached without the need for additional tools. Hence, the disclosed ring binder apparatus is recyclable, environmentally and ecologically friendly, and reusable.

### BRIEF DESCRIPTION OF THE DRAWINGS

The accompanying figures, in which like reference numerals refer to identical or functionally-similar elements throughout the separate views and which are incorporated in and form a part of the specification, further illustrate the embodiments and, together with the detailed description, serve to explain the embodiments disclosed herein.

FIG. 1 illustrates an exploded view depicting individual components of a recyclable ring binder apparatus, in accordance with a preferred embodiment;

FIG. 2 illustrates a bottom view of the recyclable ring binder apparatus in a fully opened position, in accordance with a preferred embodiment; and

FIG. 3 illustrates a plan view of the recyclable ring binder apparatus in a fully opened position, in accordance with a preferred embodiment.

### DETAILED DESCRIPTION

The particular values and configurations discussed in these non-limiting examples can be varied and are cited merely to illustrate at least one embodiment and are not intended to limit the scope thereof.

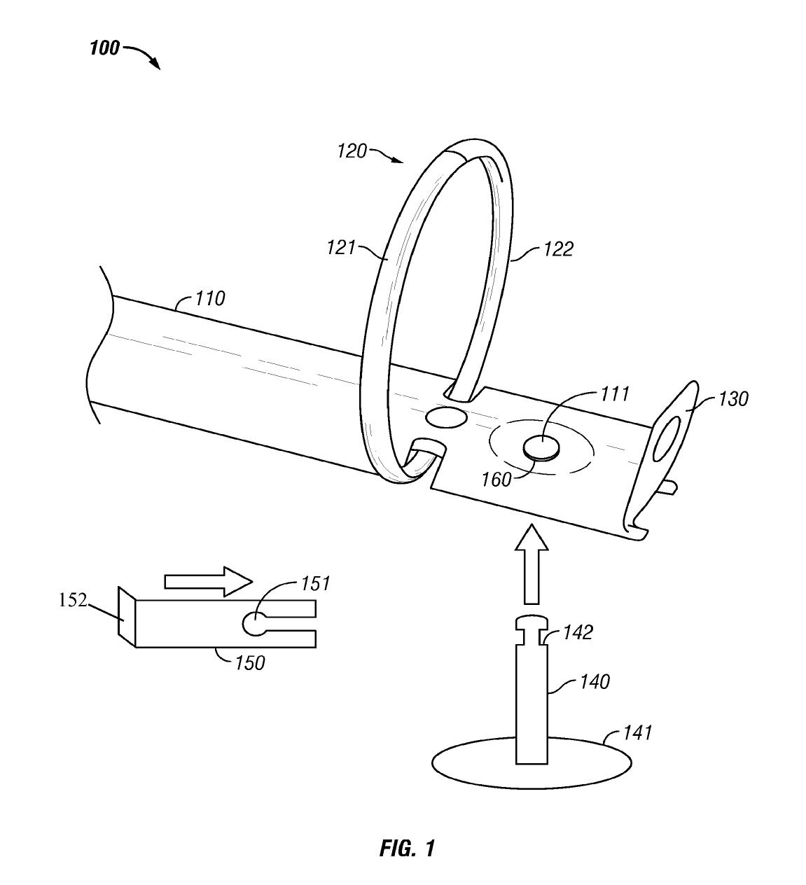

Referring to FIG. 1, an exploded view depicting individual components of a recyclable ring binder apparatus 100 is illustrated, in accordance with a preferred embodiment. The recyclable ring binder apparatus 100 can be flat and bound much like a hard back book utilizing a recycled paper or cloth tape (not shown). The recyclable ring binder apparatus 100 can be utilized for binding loose-leaf papers (not shown) to form books or booklets. The recyclable ring binder apparatus 100 comprises a ring metal 110, a post 140, and a small arched snap clamp 150 with a central opening or rounded portion 151 and a tab 152 and a clipping mechanism 160. The ring binder apparatus 100 can be available in various sizes to accommodate different sized sheets of paper and different quantities of paper.

The ring metal 110 can incorporate a set of binder rings 120 that are formed of a pair of ring halves 121 and 122. The set of binder rings 120 can be openable and closeable to hold the loose-leaf papers within the ring binder 100. The binder rings 120 can be spaced axially along the length of the ring metal 110. The ring binder 100 may have three or more binder rings 120 without departing the scope of the invention. A set of release levers 130 can be mounted on opposite ends of the ring metal 110. The set of release levers 130 can be operable by a user to open and/or close the binder rings 120 for easily and quickly loading the loose-leaf papers. Each release lever 130 can extend longitudinally of and co-planar with the ring metal 110.

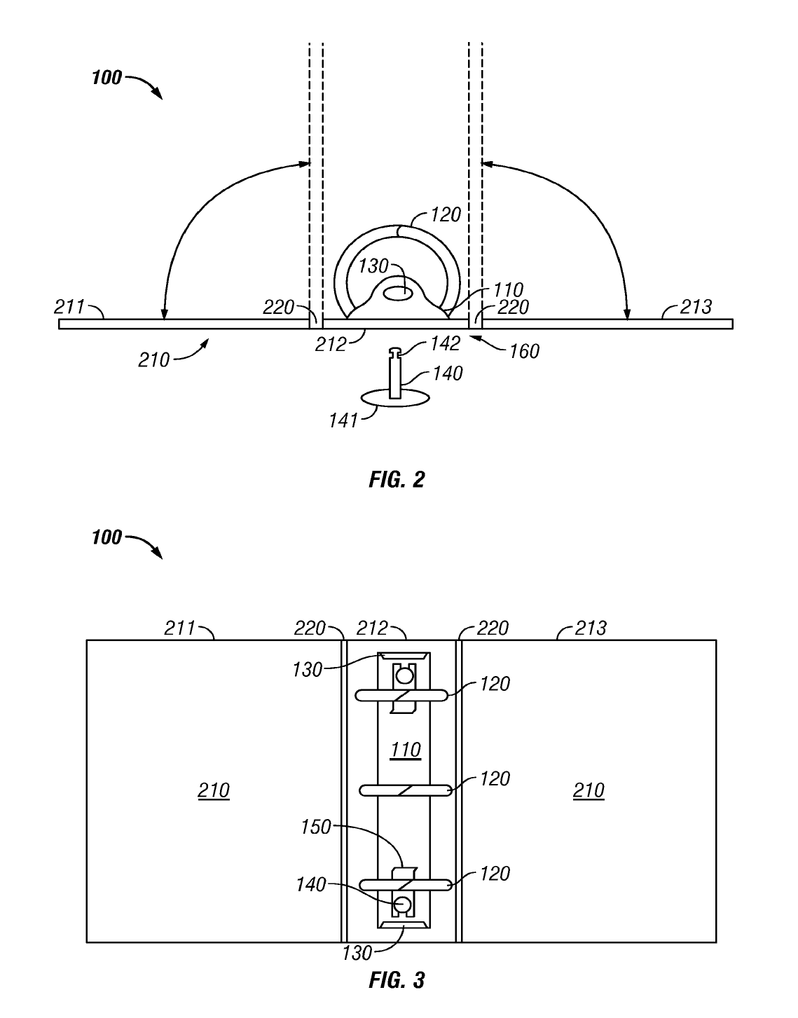

The ring metal 110 can be firmly fastened to a spine section 212 of a binder hardcover 210, as illustrated in FIG. 2, by utilizing the post 140 and the small arched snap clamp 150. The post 140 can include a head 141 and a neck 142 formed therein. The ring metal 110 can also include a hole 111 that are formed therein to receive the neck 142 of the post 140. The opening or rounded portion 151 of the snap clamp 150 can be pressed around the neck 142 of the post 140 utilizing the quick release clipping mechanism 160, after receiving the neck 142 of the post 140 in the ring metal hole 111. The tap 151 of the snap clamp 150 can be designed in accordance with the structure of the post neck 142. The snap clamp 150 can be accessed with an index finger and slid away from the post to remove the ring metal 110 from the hardcover 210. The ring metal 110, the hardcover 210, the post 140 and the snap clamp 150 can be quickly separated into their perspective categories due to the clipping mechanism 160. Hence, all components of the ring binder apparatus 100 can be recycled without any damage to the components and without increasing development and production cost.

Referring to FIG. 2, a bottom view of the recyclable ring binder apparatus 100 in a fully opened position is illustrated, in accordance with a preferred embodiment. Note that in FIGS. 1-3 identical parts or elements are generally indicated by identical reference numerals. The ring binder apparatus 100 can be applied to office, industry and many other products that are permanently attached utilizing a combination of materials such as metal, paper or plastic. The ring binder apparatus 100 can be utilized to form, but not limited to books, booklets, clipboards and photo albums with the help of simple and easily detachable components. Therefore, the ring binder apparatus 100 can be recyclable, environment friendly, ecological, green and reusable.

Moreover, the hardcover 210 of the ring binder 100 can incorporate a front section 211, a spine section 212 and a back section 213 that are usually a rigid material (e.g. cardboard, plastic, or the like). The hardcover 210 can be designed as a chipboard and/or plastic board, where the plastic board can be constructed of bio-degradable or recycled plastics. The hardcover 210 can exhibit a uniform thickness throughout its length. The front section 211, the spine section 212 and the back section 213 can be entirely covered with decorative means. The front section 211 and the back section 213 can be connected to the spine section 212 at flexible hinge grooves 220. The hinge grooves 220 enable the hardcover 210 to bend or fold along the length of the grooves 220, so that the front section 211 and the back section 213 can be rotated between a closed position and an opened position, as illustrated in FIG. 2. It should also be understood that the hinge grooves 220, by the nature of their formation as thin portions of the hardcover 210, are not as strong the thicker portions of the hardcover 210 and thus are more prone to splitting or breaking.

The ring binder apparatus 100 can be formed by the ring metal 110 provided with the set of binder rings 120. The set of binder rings 120 of the ring metal 110 are openable and closable via the release levers 130. The ring metal 110 can be bonded with the hardcover 210 by utilizing the quick release clipping mechanism 160. The clipping mechanism 160 enables the user to press the opening or rounded portion 151 of the snap clamp 150 around the neck 142 of the post 140 after inserting the post 140, through the spine section 212, into the hole 111 in the ring metal 110. Such ring binders 100 can be easily detached for recycling without the need of additional tools and without affecting conformance of the binder components.

Referring to FIG. 3, a plan view of the recyclable ring binder apparatus 100 in a fully opened position, in accordance with a preferred embodiment. Note that in FIGS. 1-3 identical parts or elements are generally indicated by identical reference numerals. The ring binder apparatus 100 can incorporate the ring metal 110, the hardcover 210, and the clipping mechanism 160. Preferably, the hardcover 210 of the binder apparatus 100 can be constructed of a completely recyclable material such that no disassembly of the detached hardcover 210 can be required prior to recycling.

The post 140 and the snap clamp 150 can be made of metal and/or plastic depending upon design consideration. It can be appreciated, of course, that other materials may be utilized to implement the post 140 and the snap clamp 150. The hardcover 210 can be removably connected to the ring metal 110 with the help of clipping mechanism 160. The opening or rounded portion 151 of the snap clamp 150 can be disengaged and removed from the neck 142 of the post 140 to disconnect the hardcover 210 from the ring metal 110. Such a ring binder apparatus 100 can be engaged and disengaged virtually an unlimited number of times.

It will be appreciated that variations of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. A recyclable ring binder apparatus, comprising:
A. a removable binder having (i) one or more among one front section, a spine section, and a back section, and (ii) a first post mounting passage;
B. a ring metal removably mounted to binder hardcover and including (i) a laterally extending ring metal body with laterally opposed ends and a center between the laterally opposed ends, (ii) a plurality of binder rings with each among the binder rings having two moveable ring portions, (iii) a first binder ring release lever in communication with the binder rings, (iv) a first post mounting hole penetrating the ring metal body;
C. a first removable ring metal mounting mechanism including (i) a first removable mounting post with a narrowed clamp mounting neck and (ii) a first arched snap clamp having a central body section, an actuation tab extending from the central body section, and a post mounting channel laterally penetrating the central body section opposite the actuation tab, with the first removable mounting post removably penetrating the first post mounting passage and the first post mounting hole, with the post neck slidably and interlockingly penetrating the post mounting channel in the first arched snap clamp, and with the post mounting channel of the first arched snap clamp extending toward the center of the ring metal and the actuation tab of the first arched snap claim extending toward an end of the ring metal.

2. The recyclable ring binder apparatus of claim 1 wherein said first arched snap clamp is slidable with respect to the post neck, whereby said ring metal can be removed from the binder.

3. The recyclable ring binder apparatus of claim 1 wherein said removable binder comprises a bio-degradable material.

4. The recyclable ring binder apparatus of claim 1 wherein said binder is a hardcover binder.

5. The recyclable ring binder apparatus of claim 1 wherein said ring metal includes a second binder release lever with the first release lever adjacent one end of said ring metal and the second release lever adjacent the other end of said ring metal.

6. The recyclable ring binder apparatus of claim 1 wherein:
A. the removable binder has a second post mounting passage;
B. the ring metal includes a second post mounting hole penetrating the ring metal body; and
C. the removable ring metal mounting mechanism includes a second removable mounting post (i) removably penetrating the second post mounting passage and second post mounting hole, and (ii) removably, slidably, and interlockingly penetrating a mating post channel in the second arched snap clamp.

7. The recyclable ring binder apparatus of claim 2 wherein:
A. the removable binder has a second post mounting passage;
B. the ring metal includes a second post mounting hole penetrating the ring metal body; and
C. the removable ring metal mounting mechanism includes a second removable mounting post (i) removably penetrating the second post mounting passage and second post mounting hole, and (ii) removably, slidably, and interlockingly penetrating a mating post channel in the second arched snap clamp.

8. The recyclable ring binder apparatus of claim 3 wherein:
A. the removable binder has a second post mounting passage;
B. the ring metal includes a second post mounting hole penetrating the ring metal body; and
C. the removable ring metal mounting mechanism includes a second removable mounting post (i) removably penetrating the second post mounting passage and second post mounting hole, and (ii) removably, slidably, and interlockingly penetrating a mating post channel in the second arched snap clamp.

9. The recyclable ring binder apparatus of claim 4 wherein:
A. the removable binder has a second post mounting passage;
B. the ring metal includes a second post mounting hole penetrating the ring metal body; and
C. the removable ring metal mounting mechanism includes a second removable mounting post (i) removably penetrating the second post mounting passage and second post mounting hole, and (ii) removably, slidably, and interlockingly penetrating a mating post channel in the second arched snap clamp.

10. The recyclable ring binder apparatus of claim 5 wherein:
A. the removable binder has a second post mounting passage;
B. the ring metal includes a second post mounting hole penetrating the ring metal body; and
C. the removable ring metal mounting mechanism includes a second removable mounting post (i) removably penetrating the second post mounting passage and second post mounting hole, and (ii) removably, slidably, and interlockingly penetrating a mating post channel in the second arched snap clamp.

11. A method of assembling a recyclable ring binder apparatus, comprising:
inserting a first removable mounting post through a first post mounting passage in a removable binder;
inserting the first removable mounting post through a first post mounting hole in a removable ring metal having opposed ends, a center, and a plurality of openable mounting rings mounted along the lateral length of the ring metal;
with a first snap clamp having an actuation end opposite a post interlocking end with a post mounting channel penetrating the post interlocking end, sliding the snap clamp post mounting channel away from an adjacent end of the removable ring metal toward the center of the ring metal and interlockingly about the first removeable mounting post.

12. The recyclable ring binder assembly method of claim 11 wherein the sliding step includes sliding the mounting channel within a narrowed neck end of the first removable mounting post.

13. The recyclable ring binder assembly method of claim 11 wherein said removable binder comprises a bio-degradable material.

14. The recyclable ring binder assembly method of claim 11 wherein said removable binder is a hardcover binder.

15. The recyclable ring binder assembly method claim 11 wherein said removable ring metal includes a first ring metal release lever adjacent one end of the ring metal and a second ring metal release lever adjacent the other end of the ring metal.

16. The recyclable ring binder assembly method of claim 11 further comprising:
inserting a second removable mounting post through a second post mounting passage in the removable binder;
inserting the second removable mounting post through a second post mounting hole in the removable ring metal; and
with a second snap clamp, sliding the snap clamp away from an adjacent end of the removable ring metal toward the center of the ring metal and interlockingly about the second removeable mounting post.

17. The recyclable ring binder assembly method of claim 12 further comprising:
inserting a second removable mounting post through a second post mounting passage in the removable binder;
inserting the second removable mounting post through a second post mounting hole in the removable ring metal; and
with a second snap clamp, sliding the snap clamp away from an adjacent end of the removable ring metal toward the center of the ring metal and interlockingly about the second removeable mounting post.

18. The recyclable ring binder assembly method of claim 13 further comprising:
inserting a second removable mounting post through a second post mounting passage in the removable binder;
inserting the second removable mounting post through a second post mounting hole in the removable ring metal; and
with a second snap clamp, sliding the snap clamp away from an adjacent end of the removable ring metal toward the center of the ring metal and interlockingly about the second removeable mounting post.

19. The recyclable ring binder assembly method of claim 14 further comprising:
inserting a second removable mounting post through a second post mounting passage in the removable binder;
inserting the second removable mounting post through a second post mounting hole in the removable ring metal; and
with a second snap clamp, sliding the snap clamp away from an adjacent end of the removable ring metal toward the center of the ring metal and interlockingly about the second removeable mounting post.

20. The recyclable ring binder assembly method of claim 15 further comprising:
inserting a second removable mounting post through a second post mounting passage in the removable binder;
inserting the second removable mounting post through a second post mounting hole in the removable ring metal; and
with a second snap clamp, sliding the snap clamp away from an adjacent end of the removable ring metal toward the center of the ring metal and interlockingly about the second removeable mounting post.
